(19) United States
(12) Patent Application Publication
(10) Pub. No.: US 2008/0016452 A1
(43) Pub. Date: Jan. 17, 2008

(54) INTERACTIVE GRAPHIC OPERATOR INTERFACE PANEL FOR SWITCHGEAR SYSTEMS

(76) Inventor: Michael Edward Pincus, Port Washington, WI (US)

Correspondence Address: QUARLES & BRADY LLP, 411 E. WISCONSIN AVENUE, SUITE 2040, MILWAUKEE, WI, 53202-4497, US

(21) Appl. No.: 11/565,201

(22) Filed: Nov. 30, 2006

Related U.S. Application Data
(60) Provisional application No. 60/741,970, filed on Dec. 2, 2005.

(51) Int. Cl. G06F 3/048

(52) U.S. Cl. 715/763

(57) ABSTRACT

An operator interface panel for electrical switchgear includes a screen that has a first section for displaying a state machine chart indicating a succession of operating states in which the switchgear can function. A second section of the screen displays a plurality of icons each depicting an action that the electrical switchgear can perform in each of the operating states. A manually operated device, such as a touch-panel, is provided to enable a user to select one of the plurality of icons, thereby directing the electrical switchgear to perform the action depicted by the selected icon. The screen has a third section that displays operational parameters associated with the presently active operating state.

### CROSS-REFERENCE TO RELATED APPLICATIONS

This application claims benefit of U.S. provisional patent application No. 60/741,970 filed Dec. 2, 2005.

### STATEMENT REGARDING FEDERALLY SPONSORED RESEARCH OR DEVELOPMENT

Not Applicable

### BACKGROUND OF THE INVENTION

1. Field of the Invention

The present invention relates to switchgear systems employed to control the coupling of one or more power sources to a load and to one another, and particularly, to control panels for such systems.

2. Description of the Related Art

Switchgear systems are widely used by customers of utility companies to determine whether and when electricity is provided to the customers' loads from the utility company via a power grid, or from other power source(s) that are under the control of the customers. Depending upon the situation, a customer may desire that all the electricity is provided from a utility company, that all of the electricity is provided from a power source operated by the customer (e.g. a gas-powered generator), or that electricity is jointly provided from both types of power sources. When electricity is provided jointly from multiple sources, the switchgear systems also are capable of determining the relative amounts of electricity that each source provides. Switchgear systems also allow customers to supply electricity that is produced by their own power sources back to the utility company or power grid, for which the customers are paid.

A switchgear system typically determines whether electricity is provided from the utility company to the customer load, or from a customer power source to the load or back to the utility company, by selectively opening and closing circuit breakers to make or break connections between the utility company, load, and customer's power source. In a conventional two-breaker switchgear system, an outside power line carrying electricity from a utility company is coupled to a customer load by a first circuit breaker, and the customer load is further coupled by a second circuit breaker to the customer power source, which is often an engine-generator set (genset). When the first and second circuit breakers are closed, power can be supplied to the load from both the utility company and the customer power source, or from the customer power source to the utility company. When only the first or second circuit breaker is closed, all power being supplied to the load comes from the utility company or customer power source, respectively.

Not all switchgear systems allow the direct coupling of a customer power source to the utility company power grid. Indeed, early switchgear systems avoided the simultaneous coupling of the two sources to one another. When it was desired to switch from supplying utility company power to the load to supplying customer power to the load, or vice-versa, a transfer was accomplished by first decoupling the power source that was originally supplying power to the customer load before coupling the other power source to the load. This basic transfer mode (called “open transition transfer”) typically is undesirable insofar as there is at least a short period of time in which no power is provided to the load. Further, switchgear systems that are only configured to perform open transition transfers do not have the capability of coupling the customer power source to the power grid for the purpose of providing power to the power grid.

Thus, modern switchgear systems typically have the capability of coupling a customer power source directly to the utility company power grid. In the case where such a switchgear system is switching between providing all power to the load from the utility company and providing all power from a customer power source, or vice-versa, there is a period of time in which both the utility company and the customer power sources are coupled to one another and coupled to the load. This is desirable insofar as it allows for seamless transitioning between power sources from the perspective of the load. The transfer mode, in which the period of time during which both sources are coupled to one another is relatively short, is called a “closed transition transfer”. A mode, having a longer transfer period during which the relative contributions of power from the two power sources are respectively increased and decreased slowly with respect to one another, is called a “soft load transfer” or “load-ramping transfer.”

However, in order to provide for closed transition or soft load transfers, the complexity of the design of a switchgear system becomes greatly increased. In addition to controlling the timing of the opening and closing of the circuit breakers, the switchgear system must additionally control the operation of the customer power source so that its power output becomes synchronized with the power of the utility company power grid. That is, before the switchgear system can close both of the circuit breakers so that the customer power source is coupled directly to the power grid, the switch gear system must determine that the customer power source is providing electricity of the same voltage, frequency and phase angle of the electricity provided by the power grid.

In addition to the complexity associated with performing closed transition or soft load transfers, modern switchgear systems are further complicated because they are often designed to perform switching transfers (or to otherwise change the switching status of the circuit breakers) only under certain specified conditions. For example, a standard switchgear system is often designed to maintain the connection between the utility company and the customer load in a normal operating mode, and to only break this connection when there is an emergency condition rendering the utility company power unavailable, in response to which the switchgear system transfers the load to the customer power source in an emergency standby operating mode. Another type of switchgear system is designed to leave the normal operating mode and enter an interruptible rate (or curtailable power) operating mode whenever the amount of electricity from the utility company exceeds a certain level (or some related quantity such as price exceeds a certain level), or whenever the utility company provides a command to do so.

An additional type of switchgear system is designed to operate so that the utility company supplies all electricity required by the load in a normal operating mode until the amount of electricity (or total electricity cost) exceeds a certain level, at which time the switchgear system enters a peak shaving mode of operation and causes the customer power source to become also coupled to the load. The customer power source then supplies any additional electricity that is needed above the level. A further type of switchgear system is designed to allow a customer power source to supply electricity back to the power grid, in an export-to-utility company operating mode. Moreover, some switchgear systems are designed to perform certain transfers or other switching operations only in response to commands or information from outside sources such as the utility company. Designing a switchgear system to operate in any one of these operating modes, or in response to different commands or other information, further increases the complexity of the switchgear system.

The customer configures, controls and monitors the switchgear system via a computerized Human-Machine Interface (HMI). A common methodology for programming the HMI simply creates an electronic version of the required discrete meters, indicators, and switches that would have been employed with the equipment if there was no HMI. The user experience and interaction essentially remains the same for equipment with or without an HMI. It can be argued that the user experience has been degraded by an HMI programmed in this way. Users often times are presented with too much information and are confused as to how to control the switchgear and where information that they need is located. If the equipment had no HMI, the users could readily determine the status of the entire system. In both cases the user had to be trained in the operation of the equipment, they had to understand what reactions their different actions cause. They had to know where to look to see such reactions. If something went wrong with an operational sequence, the users had to know what actions could be taken and the result of each such action. The current state of HMI programming does not significantly enhance the user experience. It primarily saves cost to the manufacturer of the equipment being controlled.

### SUMMARY OF THE INVENTION

The present invention is an operator interface for an electrical switchgear system that controls application of electricity from a first source and a second source to a load. The operator interface includes a screen having a first section for displaying a state machine chart that indicates a succession of operating states in which the switchgear can function. The screen has a second section for displaying a plurality of icons each depicting an action of the electrical switchgear. A preferred embodiment has a third section of the screen for displaying operational parameters, such as for example voltage, amperage, frequency, phase angle and power factor of the electricity being switched.

A manually operated device, such as a touch panel for example, enables a user to select one of the plurality of icons, thereby issuing a command from the operator interface panel for the electrical switchgear to perform the action depicted by that selected icon. In a preferred embodiment, each of the icons is associated with an operating state and a command is issued only from those icons associated with the presently active state of the electrical switchgear.

The present interactive state machine chart control is a paradigm shift in how information is presented to the user and how the user interacts with a switchgear system. Since the sequences of operation are presented by a state machine chart, an inexperienced user readily perceives what is going to happen when a particular icon is selected or another action is commanded. The users see the results of their actions along with all subsequent reactions. The operator interface panel shows what is happening at each step of the equipment control process and automatically displays the relevant system status so the user can verify that the equipment is functioning correctly. If at any point in the process the user has to make a decision, the operator interface panel displays the available choices and shows what will happen for each choice. The user does not have to memorize a manual as the operator interface is self-documenting. If at any point in the process there is an abnormal condition, the operator interface panel indicates the problem and shows the user the choices they have in instructing the system what to do next.

### BRIEF DESCRIPTION OF THE DRAWINGS

FIG. 1 is a block diagram showing an exemplary configurable switchgear system in accordance with one embodiment of the present invention, which is coupled to a genset, a load, and a utility company;

FIG. 2 is a block diagram showing software modules, programs and other information that is employed by the switchgear system; and

FIGS. 3A-D are pictorial representations of a succession of display screens produced by an operator interface panel that forms part of the switchgear system.

### DETAILED DESCRIPTION OF THE PREFERRED EMBODIMENTS

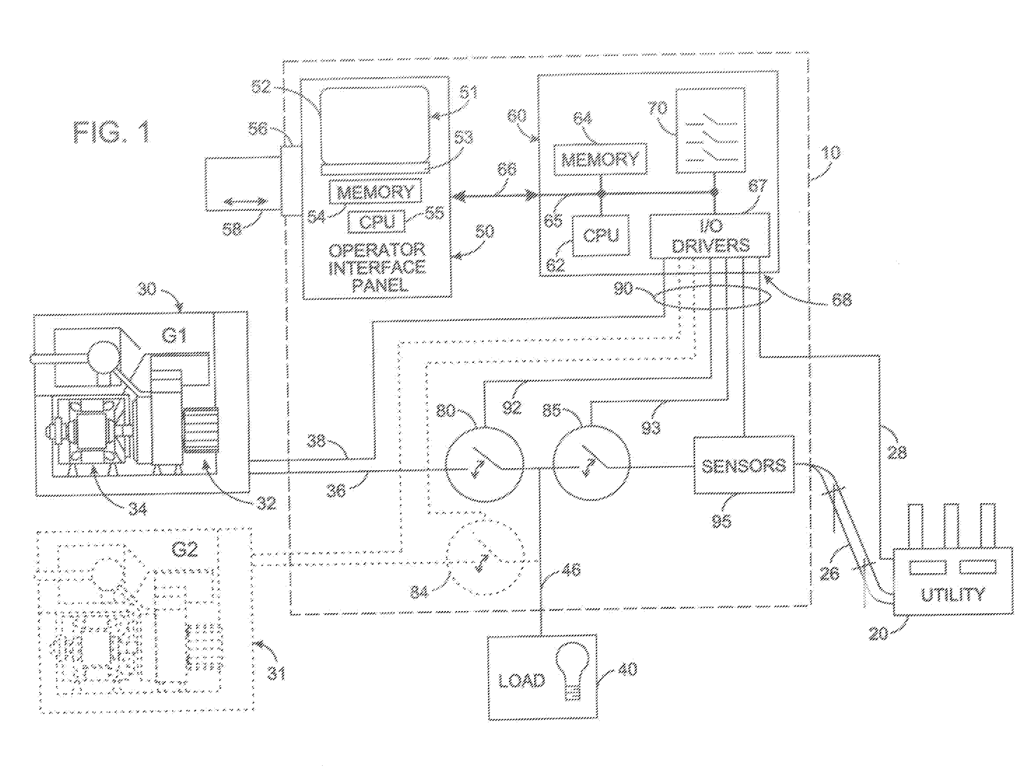

Referring to FIG. 1, a configurable electrical switchgear system 10 typically is coupled to a utility company 20, a generator set (or genset) 30, and an electrical load 40. It should be understood that one or more additional gensets 31 could be provided to ensure that sufficient backup power is available for the load 40. The switchgear system 10 operates to determine whether electricity from the utility company 20 is provided to the load 40, whether power from the genset 30 is provided to the load, and/or whether power from the genset 30 is provided to the utility company 20 or more generally to the power grid to which the utility company is providing electricity. The switchgear system 10 is coupled to the utility company 20 by a power line 26, to the genset 30 by a genset power cable 36, and to the load 40 by a load power cable 46. The genset 30 is a conventional apparatus having an internal combustion engine 32, such as the Series 60, Series 2000 or Series 4000 engines manufactured by the Detroit Diesel Co. of Detroit, Mich., U.S.A.; as well as an alternator 34, such as a 3-phase synchronous alternator manufactured by Marathon Electric Manufacturing Corp. of Wausau, Wis., U.S.A. However, the genset 30 can in alternate embodiments be replaced with different types of engines and alternators or even other types of power sources, such as micro-turbines or fuel cells.

The switchgear system 10 includes an operator interface panel 50, a controller 60, a plurality of relays 70, a generator circuit breaker 80, and a utility company circuit breaker 85. Based upon control signals provided by the controller 60 to the generator circuit breaker 80, the genset 30 is coupled to or decoupled from the load 40 and, depending upon the state of the utility company circuit breaker 85, to and from the utility company 20. At least one other genset 31 can be coupled to the load power cable 46 by another generator circuit breaker 84 and these additional devices are operated in unison with or independently of genset 30 and generator circuit breaker 80. Likewise, depending upon control signals from the controller 60 to the utility company circuit breaker 85, the utility company 20 (or power grid) is coupled to or decoupled from the load 40 and, depending upon the status of the generator circuit breaker 80, to and from the genset 30. The circuit breakers 80 and 85 can be any one of a number of different types of commercially available devices, for example, the Masterpact® universal power circuit breaker manufactured by Square D Co. of Cedar Rapids, Iowa, U.S.A. The exact operation of the switchgear system 10 in controlling the circuit breakers 80 and 85 is discussed further below.

The operator interface panel 50 includes a display device 51 that has a screen 52 for displaying information to a human user and a manually operated device 53 for receiving commands from the human user. Preferably the such display device is a conventional touch screen in which the manually operated device 53 is a mechanism that detects a location on the screen that is touched by the user to select an icon displayed at that location. The operator interface panel 50 may be a conventional personal computer with a standard touch screen, a memory 54, input/output ports, and a central processing unit (CPU) 55, such as a microcomputer. The operator interface panel 50 is coupled to the controller 60 by way of a communication link 66. The communications across the communication link 66 can proceed according to any one of a number of well known protocols. A plug-in card 58, that is inserted into a PCMIA connector of the operator interface panel 50, contains a memory that stores application software programs and configuration settings for the operation of the switchgear system 10.

As shown in FIG. 1, the controller 60 includes a central processing unit (CPU) 62, a memory 64, and a plurality of protective relays 70. Additionally, the controller 60 comprises a plurality of input/output (I/O) ports 68 for communicating with the circuit breakers 80 and 85, and a variety of other elements. The I/O ports 68 include a plurality of analog inputs, discrete inputs, analog outputs and discrete outputs, as further discussed below. The signals at I/O ports 68 are provided and received by a plurality of corresponding input/output (I/O) drivers 67, respectively. For example, the controller 60 is a conventional programmable logic controller commonly employed to operate a wide variety of industrial equipment.

The controller 60 governs the performance of a variety of functions of the switchgear system 10. In particular, the controller 60 controls operation of each circuit breaker 80 and 85, including both whether and when the circuit breakers are opened or closed and the manner or timing in which the circuit breakers are opened or closed. The operation of the controller 60 in this regard is central the operation and purpose of the switchgear system 10 insofar as it concerns, whether and in what manner power is provided to and from the utility company 20, from the genset 30, and to load 40. In addition to controlling the circuit breakers 80 and 85, the controller 60 also influences the operation of genset 30 via a genset communication link 38, and responds to or communicates with the utility company 20 by way of a utility company communication link 28. The genset communication link 38 conveys data to the controller 60 regarding characteristics (such as voltage, amperage, frequency and phase angle) of the electricity being supplied by the genset 30.

The relays 70 that are employed vary depending on the specific requirements for the particular installation of the switchgear system 10. Typical relays include protective devices that open one or both circuit breakers 80 and 85 to protect the genset 30, the utility company 20, or the load 40 during a fault condition, such as when the voltage or frequency of the electricity is outside acceptable defined ranges, when electrical current flows in a reverse direction than that desired, and when an incorrect electrical phase sequence occurs (none of which conditions is shown in FIG. 1). Depending upon the particular application, additional relays also can be employed outside of controller 60, in which case the relays are controlled by way of one or more communication links that are coupled to the I/O drivers 67.

The CPU 62 is coupled to the memory 64, to the protective relays 70, and to the plurality of I/O drivers 67 by an internal data bus 65. The I/O drivers 67 include a variety of discrete input drivers, discrete output drivers, analog input drivers and analog output drivers. The I/O drivers 67 provide and receive signals at I/O ports 68 that are communicated over multiple communication links 90. Discrete input and output drivers of the I/O drivers 67 are used to communicate information to and from the genset circuit breaker 80 and the utility company circuit breaker 85 over respective communication links 92 and 93. The analog input drivers of the I/O drivers 67 are capable of receiving status information concerning a variety of parameters such as voltage availability, electrical current availability, or engine speed. Information is exchanged over each of the communication links 90 (as well as internal data bus 65) using a standard protocol, including serial, parallel, hardware-based or any other type of communication format. One of the communication links 90 is connected to a set of sensors 95 that sense characteristics (such as voltage, amperage, frequency, and phase angle) of the electricity being supplied by the utility company.

Additionally, the controller 60 provides commands to the genset 30 by way of a discrete output driver and the genset communication link 38. These commands are typically provided directly to an engine governor and voltage regulator (not shown) in the genset 30, although the commands can be provided to an intermediate control device such as an engine control module (not shown). Such commands in particular enable the controller 60 to influence the genset voltage regulator, which in turn alters the field current of the alternator 34 and thereby influences the output voltage from the genset. The commands provided to the genset 30 further allow the controller 60 to control or influence the speed of engine 32, which affects the voltage level and frequency of the power produced by the genset. Additional commands allow the controller 60 to start or stop the engine 32.

The communication link 28 between the controller 60 and the utility company 20 permits the utility company to provide a signal indicating when it is necessary or desirable for a greater proportion of the power requirement of the load 40 to be satisfied by the genset 30 instead of the utility company 20. As may be desired, the communication link 28 can involve any form of analog, digital, serial, parallel or other communication modality, and as a result be coupled to input and output ports of the I/O ports 68 that are compatible with the signal form employed. The communication link 28 also can allow other types of communication between the switchgear system 10 and the utility company 20 to occur. In certain applications, the utility company 20 has the ability to influence the amount and type of power provided by the genset 30 by providing commands to the switchgear system 10, or is able to obtain information regarding the operation of the switchgear system, the genset, or the load 40.

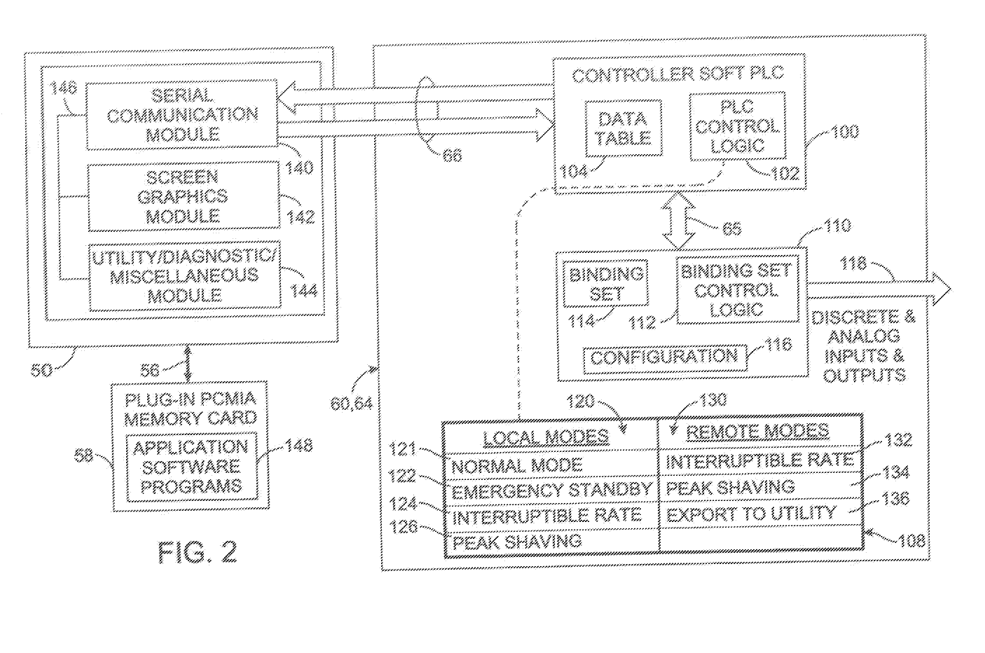

Referring to FIGS. 1 and 2, software employed by switchgear system 10 include software modules and programs stored in the memory 64 of the controller 60 and also software stored in the memory 54 and the plug-in card 58 of the operator interface panel 50. The software modules contained in the controller memory 64 comprise a first module 100 relating to a controller soft programmable logic controller (PLC) that includes PLC control logic software 102 and a data table 104. The software modules additionally include a second module 110 that constitutes control logic software 112, binding set software 114, and configuration parameters 116. The software of the second module 110 is used to determine the operation of the discrete and analog input and output drivers of I/O drivers 67.

The binding set software 114, PLC control logic software 102 and configuration parameters 116 are used to determine how the controller 60 operates in opening and closing the genset and utility company circuit breakers 80 and 85 in accordance with a variety of different switching modes, and by way of a variety of different electricity source transfers and other switching actions. The controller 60 is capable of controlling the operation of circuit breakers 80 and 85 in twelve different operating modes.

The binding set software 114 in particular determines how the various components of the switchgear system 10 are selectively connected with one another to perform different switching operations in the different modes. For example, the binding set software 114 determines how functional elements embodied in software such as a synchronizer, load-sharing module, sync-check module, VAR export module, and zero power transfer modules (not shown) are interconnected for cooperative operation. The PLC control logic software 102 determines the sequence of control operations performed by the controller 60 in order to carry out the different switching operations, including the common control operations that are necessary to couple the genset 30 to the utility company 20.

The configuration parameters 116 include various parameters and other data used by the controller 60 to perform the switching procedures in the various operating modes, in accordance with the PLC control logic software 102 and the binding set software 114. The software modules 100 and 110, and particularly the binding set control logic software 112 and the PLC control logic software 102, also enable monitoring of the electricity provided to and from the utility company 20, the electricity produced by the genset 30, and the electricity furnished to the load 40. This monitoring can produce information about power being provided in terms of the real power (in kilowatts), the reactive power (in KiloVars), the complex power (in kVA), a power factor, the volts or amps, the frequencies and/or phase angles of the voltages or currents, and other characteristics.

As represented by block 108 in FIG. 2, the controller 60 can direct the switchgear system 10 to operate in multiple operating modes that include a first set of modes, referred to as “local modes” 120, and a second set of modes, referred to as “remote modes” 130. The controller 60 operates in one of the local operating modes 120 when the switchgear system 10 is not receiving any control commands or other signals from the utility company 20 or any other outside source other than the genset 30 and/or load 40. The controller 60 functions in a remote operating modes 130 when it is receiving control commands or signals from utility company 20 (or some other outside source). The local modes 120 include a normal operating mode 121, an emergency standby operating mode 122, an interruptible rate operating mode 124 and a peak shaving operating mode 126, while the remote modes 130 include an interruptible rate operating mode 132, a peak shaving operating mode 134, and an export-to-utility operating mode 136.

Each of the local and remote operating modes 120 and 130 corresponds to a particular manner of controlling the switching status of the circuit breakers 80 and 85 that results in a particular power flow from the utility company 20 to the load 40, from the genset 30 to the load, or from the genset to the utility company, depending upon how the genset and utility company power sources are controlled. The default mode in which the utility company 20 is able to provide all desired power, the utility company circuit breaker 85 is closed, and the genset circuit breaker 80 is open, is the normal operating mode 121. The normal operating mode 121 is one of the local modes 120, since in the normal mode the switchgear system 10 is not receiving any signals from outside sources. The protective relays 70 can be used to determine whether the utility company 20 is properly providing all desired power such that the switchgear system 10 can remain in the normal operating mode 121, or whether the power from the utility company is outside appropriate setpoints established by the relays, which indicates that there is a problem in the flow of power from the utility company.

As discussed further below, the controller 60 switches from the normal operating mode 121 to another local mode 120 or to a remote mode 130 when certain triggering events occur. Although the controller 60 is programmed to function in any of the local or remote modes 120 and 130, in the preferred embodiment, the actual subset of modes in which the controller 60 operates depends upon the application software programs 148 stored on the particular plug-in card 58 that is employed. That is, the specific plug-in card 58 used at any given time determines how the controller 60 and switchgear system 10 are configured to operate at that time, in terms of their operating modes and the switching operations they may perform.

The controller 60 usually remains in the normal operating mode 121 unless and until such time as the utility company 20 is unable to provide sufficient power for the load 40 (e.g. the power line 26 fails in a storm), at which time the controller 60 enters the emergency standby operating mode 122. In that latter mode, the controller 60 causes the utility company circuit breaker 85 to open and causes the genset circuit breaker 80 to close, thereby applying power from the genset 30 to the load 40. If the genset 30 is not operating at the time the utility company 20 is determined to be unable to provide sufficient power, before closing the genset circuit breaker 80, the controller 60 sends a command instructing the genset by to start operating.

The interruptible rate operating mode 124 (also known as the curtailable power mode), is not utilized until a triggering event occurs. The triggering event that causes a transition from the normal operating mode 121 into the interruptible rate operating mode 124 typically is when the controller 60 determines that the power delivered by the utility company 20 exceeds a preset level. That preset level is defined by data stored in the plug-in card 58. Upon entering the interruptible rate operating mode 124, the controller 60 performs a load transfer, in which the utility company circuit breaker 85 is opened and the genset circuit breaker 80 is closed. As a result of the load transfer, the customer equipment (the switchgear system 10, genset 30 and load 40) operates independently from the utility company source. The controller 60 leaves interruptible rate operating mode 124 and returns to the normal operating mode 121 when the power required by the load 40 no longer exceeds the preset level.

With the respect to the peak shaving mode 126 of operation, the controller 60 remains in the normal operating mode 121, in which power is supplied only from the utility company 20, until such time as the power levels demanded by the load exceed some maximum threshold. When that time occurs, the controller 60 enters the peak shaving mode 126 where the genset circuit breaker 80 is closed so that at least a portion of the power demanded by the load 40 is supplied by the genset 30, in addition to the power already being provided from the utility company 20.

The controller 60 exits the peak shaving mode 126 when the power levels demanded by the load no longer exceed the maximum threshold or fall below some other defined magnitude. When such as event occurs, the controller 60 reduces the power provided by the genset 30 (e.g. in linear fashion) until such time as the genset circuit breaker 80 can be opened, after which the controller 60 returns to the normal operating mode 121. The relative power contributions from the utility company 20 and the genset 30 in the peak shaving mode 126 can vary depending upon the particular implementation of that mode. In one embodiment, the switchgear system 10 controls the genset 30 so that the power contribution from the utility company 20 is capped and the genset furnishes the remaining amount of power required by the load 40. In another embodiment, the power contribution from the genset 30 is capped, and the utility company 20 provides any remaining power that is required.

One of the remote modes 130 is the interruptible rate operating mode 132, which operates in much the same way as the interruptible rate operating mode 124 of the local modes 120, except enter into this mode now is in response to a signal from the utility company via the communication link 28. That signal, which is indicative of a desire on the part of the utility company 20 to reduce or limit consumption of its power by the load 40, can be as simple as a switch contact closure. However, in alternate embodiments, the communication between the utility company 20 and the switchgear system 10 are more complex and involve building automation or SCADA (System Control And Data Acquisition) systems. As with the interruptible rate operating mode 124, the controller 60 returns to the normal operating mode 121 from the interruptible rate operating mode 132 once the signal from the utility company 20 is no longer valid.

The peak shaving mode 134 of the remote modes 130 also is similar to the local peak shaving mode 126, except peak shaving now occurs only in response to a signal from the utility company 20. The signal indicates that the power level demanded by the load 40 has exceeded some threshold value, such that the controller 60 then determines production and delivery of power by the genset 30 to the load 40 is justified. Depending upon the specific embodiment, the signal from the utility company 20 can provide different types of information that allows the controller 60 to determine that peak shaving is appropriate. The controller 60 exits the peak shaving mode once the signal from the utility company 20 is removed or changed, indicating that peak shaving is no longer appropriate.

Another of the remote modes 130 is the export-to-utility operating mode 136, in which the customer is allowed to generate power at the genset 30, and supply that power back to the utility company 20 (or the power grid), for which the customer will be paid. As with respect to the other remote modes 130, the entry into and exiting from the export-to-utility operating mode 136 is again determined by the controller 60 based upon one or more signals from the utility company 20. Upon entry into the export-to-utility operating mode 136, both the genset circuit breaker 80 and the utility company circuit breaker 85 are closed to allow electricity flow.

At least two methods of operation in the export-to-utility operating mode 136 are possible. One method of exporting power is to load the genset 30 to a preset fixed (base-load) kilowatt level, and direct the surplus electricity to the power grid when the output of the genset 30 exceeds local load requirements. In a second method, the operator is allowed to determine the amount of electricity that is directed to the power grid based upon the level of the load 40 and the capacity of the genset 30; although the output power of the genset is allowed to fluctuate depending upon load 40, the level of exported electricity remains constant.

The controller 60 is designed so that any remote mode 130 generally takes precedence over the local modes 120. That is, in the local normal mode 121 upon receiving a signal from the utility company discussed above, the controller 60 enters into the appropriate remote mode 130. In alternate embodiments, other prioritization schemes can be employed.

In controlling the switchgear system 10 in the various local and remote modes 120 and 130, the controller 60 specifically also controls the transfers and other switching operations of the circuit breakers 80 and 85. There are at least three types of transfers in which the switching statuses of the genset circuit breaker 80 and the utility company circuit breaker 85 are reversed in order to change the power source providing power to the load 40, namely a closed transition transfer, a soft load transfer, and an open transition transfer.

With respect to the closed transition transfer, the transfer begins in an initial operating state in which either the genset circuit breaker 80 or the utility company circuit breaker 85 is closed, and the other circuit breaker is open. Thus power being provided to the load 40 comes from only one of the genset 30 or the utility company 20. In order to allow closure of both circuit breakers 80 and 85 at the same time, the controller 60 then controls the operation of the genset 30 so that the magnitude, frequency and phase angle of the genset output voltage matches those parameters of the electricity presently received from the utility company 20. If the initial operating state is one in which the utility company 20 is providing all the power to the load 40 and the genset 30 is initially off, the controller 60 additionally provides a command to start the genset 30.

After the output of the genset 30 matches the power characteristics of the utility company 20, the circuit breaker that was originally open can then be closed resulting in both the genset circuit breaker 80 and the utility company circuit breaker 85 being closed simultaneously. As a consequence, either both the utility company 20 and the genset 30 are supplying power to the load 40, or the genset 30 is providing power to the utility company 20 (in addition to the load 40). After both circuit breakers 80 and 85 have been closed for a period of time, the circuit breaker that was originally closed is opened. Thus, if in the initial state of operation the utility company 20 was supplying all the necessary power to the load 40, after the transfer, all the power for the load 40 is being supplied by the genset 30, and vice-versa.

The soft load transfer is similar to the closed transition transfer except that the period of time during which both circuit breakers 80 and 85 are closed is longer. This allows the switchgear system 10 to have a longer time to adjust the relative contributions of power by the utility company 20 and the genset 30 to the load 40 so that the original power source can be phased out and the new power source can be phased in.

A third transfer is the open transition transfer. To perform the open transition transfer, whichever one of the circuit breakers 80 and 85 was initially closed is opened prior to closure of the other circuit breaker, thereby creating a period of time in which no electricity flows from the utility company 20 and the genset 30. This open transition transfer has the disadvantage of including a period of time in which the load 40 does not receive electricity.

Depending upon the software that is presently being executed by the controller 60, operation in any of the emergency standby operating mode 122 and the interruptible rate operating modes 124 and 132 can proceed in the manner of any one of the closed transition transfer, the soft transfer, and the open transition transfer, although the open transition transfer is seldom performed. It should be noted that a full transfer of the load does not occur with respect to the peak shaving modes 126 and 134 and the export-to-utility mode 136. Rather, the switchgear system 10 performs a different switching operation that proceeds from a operating state in which only one of the two circuit breakers 80 and 85 (typically, the utility company circuit breaker 85) is closed to a state in which both the circuit breakers are closed. Nevertheless, in proceeding from the first state to the second state, the controller 60 still must accurately control the operation of the genset 30 so that its output voltage, frequency and phase angle matches that of the power from the utility company 20.

Referring still to FIGS. 1 and 2, the memory 54 of the operator interface panel 50 also includes several software modules or programs. Among these is a serial communication module 140, which governs communication over a communication link 66 between the controller 60 and the operator interface panel. There also is a screen graphics module 142, which includes software for controlling operation of the touch screen 52 and a utility/diagnostic/miscellaneous module 144, which contains the BIOS of the operator interface panel 50 and enables monitoring and processing information within the controller 60, including housekeeping functions.

All these software modules 140, 142 and 144 are coupled by a data bus 146 within the operator interface panel 50. The internal data bus 65 and the data bus 146, as shown in FIG. 2, are meant to indicate the existence of communications between what are separately functioning programming modules that interrelate with one another and, therefore, require some form of communication between the modules. However, the internal data bus 65 and data bus 146 are meant to be exemplary of any one of a number of different forms of communications, links or procedures that allow for the interaction and integration of the software and other information in the modules with one another.

As shown in FIG. 2, the plug-in card 58 is a memory card storing application software programs 148. When the plug-in card 58 is coupled to the switchgear system 10, particularly by way of plug 56, the operator interface panel 50 has access to the stored application software programs 148. The application software programs 148 enable the operator interface panel 50 to access information relating to certain of the local and remote modes 120 and 130, to enable those particular modes of operation, and also to access other configuration steps of the switchgear system 10 as necessary.

While all the necessary software programming for operation in each of the local and remote modes 120 and 130 described above resides in the software modules 100 and 110 of the controller 60, in the preferred embodiment the controller 60 only causes the switchgear system 10 to operate in a subset of those operating modes upon signals communicated from the operator interface panel 50. Those signals are generated by the application software programs 148 stored on the particular plug-in card 58 that is inserted into the operator interface panel. That is, the application software programs 148 of any given plug-in card 58 limit the operation of the controller 60 to a subset of all the local mode and remote modes of operation 120 and 130 that are possible, for example, operation may be limited to a single remote and a single local mode. The exact number of modes to which the operation of the controller 60 is restricted varies depending upon the particular application of the switchgear system 10. However, in certain embodiments all the available local and remote modes can be accessed and enabled by way of the operator interface panel when a “universal” plug-in card is utilized.

The operator interface panel 50 serves a number of functions. It enables the switchgear system 10 to be configured for the particular task at hand, including selection of the desired mode of operation and selection of certain operating parameters associated with that operating mode. In addition, the operator interface panel 50 monitors important operating parameters during operation of the switchgear system 10 and displays those parameters to the operator. Input devices also are provided on the operator interface panel that enable the operator to manually select functional options. The latter two operator interface panel functions are the subject of the present invention.

After the system has been configured for a particular mode of operation, the operator interface panel 50 operates under program control to monitor the status of the utility company 20, the load 40 and the genset 30 and, in response to that monitoring, command transitions from one state to another state as required to perform the functions associated with the selected mode of operation. It is a discovery of the present invention that the operator interface panel 50 can be made easier to use and far more informative if the multi-state operation of the switchgear system 10 is exploited.

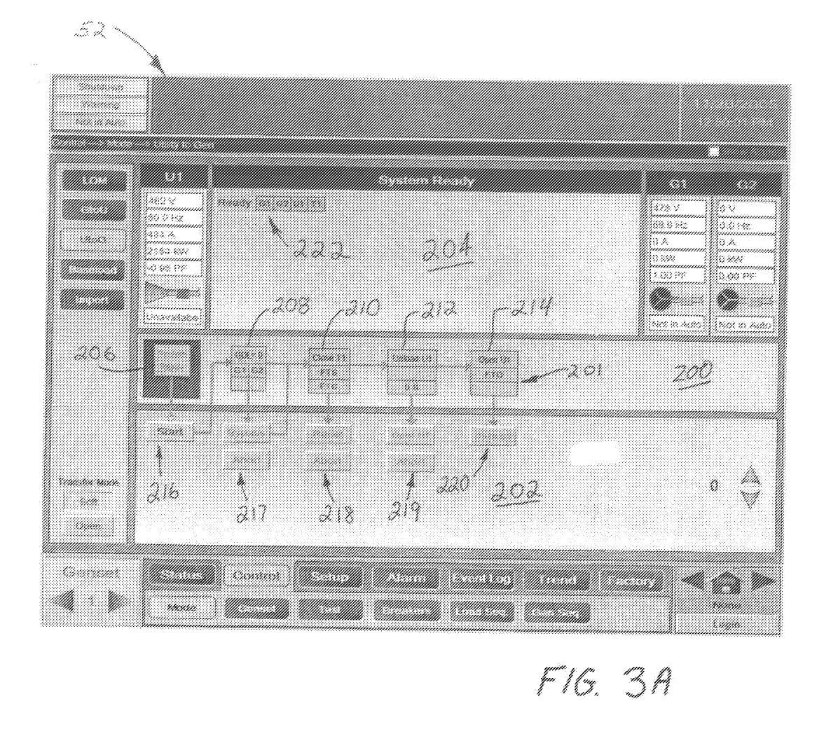

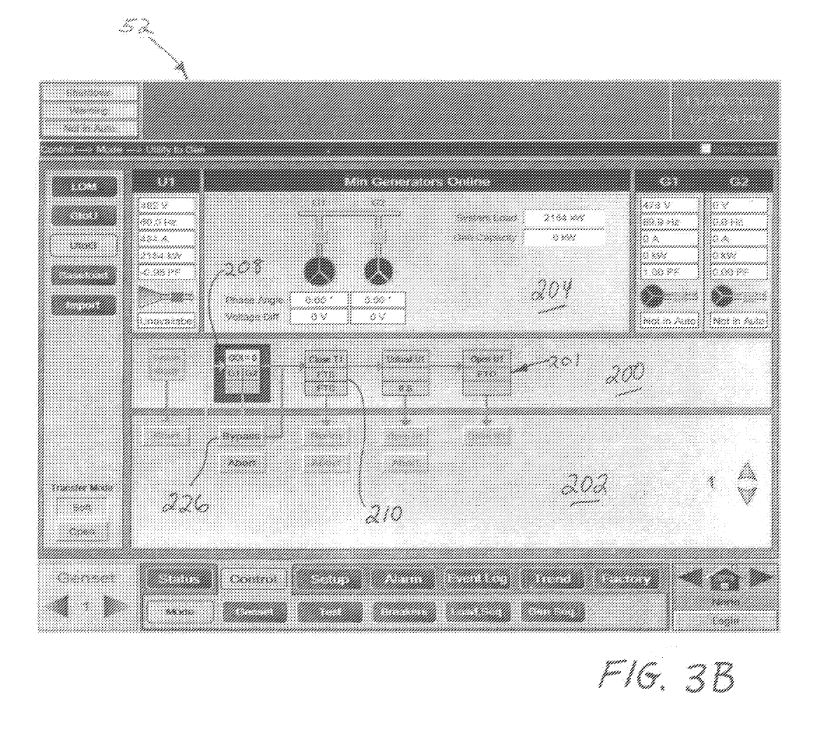

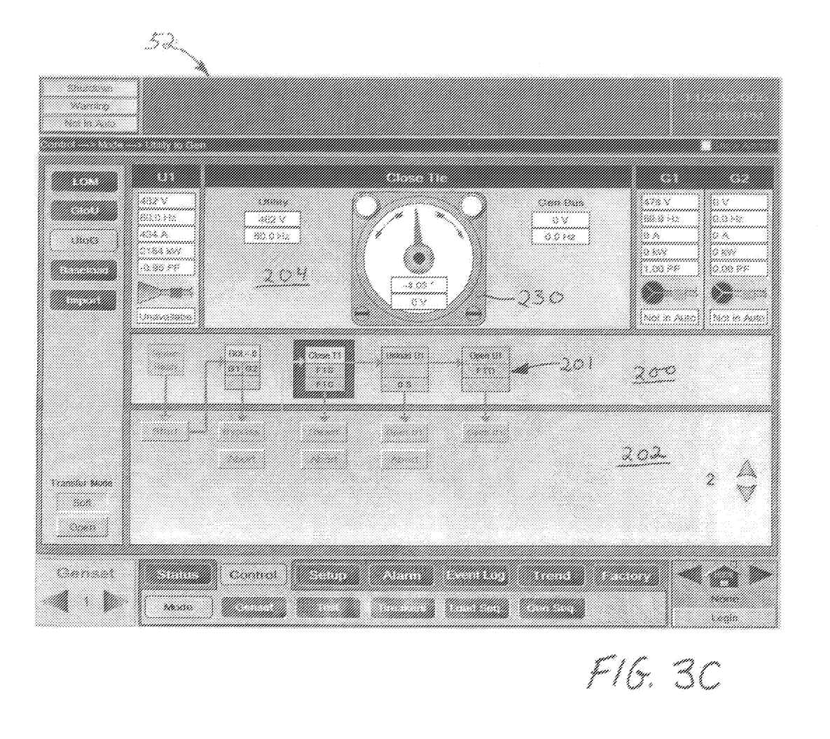

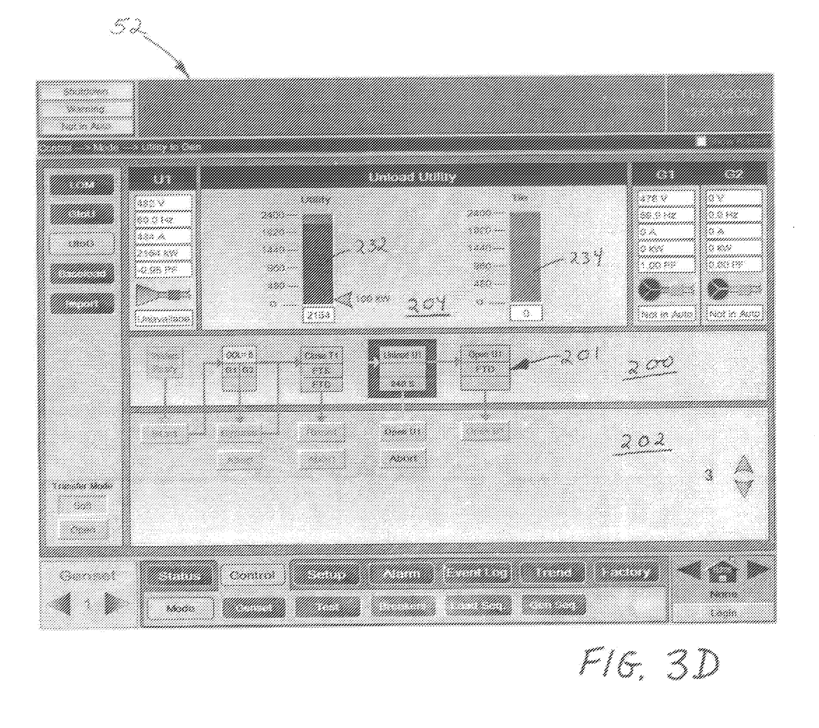

Referring particularly to FIGS. 3A-D, the display on the operator interface panel 50 is divided into three sections: a state machine chart 201 section 200; a control panel section 202; and a system monitor section 204. In the preferred embodiment, all three sections 200, 202 and 204 are part of a single touch-panel display screen which also includes sections pertaining to other system operations.

The state machine chart section 200 displays a state machine chart, or diagram, 201 that contains a function block for each operating state that the switchgear system 10 can assume in its current mode of operation. In the example shown in FIGS. 3A-D, the switchgear system can be in any one of five operating states indicated by function blocks 206, 208, 210, 212 and 214 while in the current mode of operation. In FIG. 3A the system is shown in the “system ready” operating state and the function block 206 is highlighted on the screen as depicting the presently active state.

Disposed below the state machine chart section 200 is the control panel section 202 which displays icons in the form of images of input buttons or switches 216-220 associated with each of the respective function blocks 206-214. These icons provide the operator selectable input devices on the screen 51 which upon being touched by the operator designate actions to be performed by the switchgear system 10. Each iconic switch button 216-220 is shown linked or associated with one of the operating states 208-214 of the state machine chart 201, thus designating actions that may be performed in that operating state. The operator interface panel 50 accepts an operator input only from the switch button associated with the presently active operating state. In FIG. 3A for example, the switchgear system 10 is depicted in the “system ready” operating state and “start” button 216 is highlighted as the only icon enabled for operator input in this operating state.

Disposed above the state machine state chart section 200 is the system monitor section 204. This portion of the display shows the status of inputs and outputs of the controller 60 and the switchgear system 10 along with the values of system operating parameters that are pertinent to the presently active operating state.

As the system is active in each of the operating states that are possible in the current mode of operation, the corresponding function block 206-214 in the state machine chart 201 is highlighted. Simultaneously, the system parameters that should be monitored by the operator while in this operating state are displayed in the monitor section 204, and the manual inputs that are selectable while in this operating state are displayed and enabled in the control panel section 202.

The exemplary display depicted in FIG. 3A is for the System Ready operating state as denoted by block 206 being highlighted. The system parameters and inputs associated with this active operating state are for a switchgear system 10 that has two gensets, designated G1 and G2. The statuses of both gensets and other system elements are indicated as “ready” at area 222 in the monitor section 204. While there are a multitude of other system parameters that can be displayed, these parameters shown in area 222 are deemed to be the only ones the operator need monitor when the apparatus is in the “system ready” operating state.

The appearance of the screen 52 in the Generator On Line (GOL) state is shown in FIG. 3B and that operating state being presently active is indicated by block 208 being highlighted. At this time, the monitor section 204 displays operational parameters of the two gensets G1 and G2 which parameters include voltage, amperage, wattage, frequency, phase angle and power factor. An example of the screen display for the Close Tie operating state, in which one or both gensets feed electricity into the grid of the utility company 20 are connected to the load, is given in FIG. 3C. The monitor section 204 now displays a dial that indicates the direction of current flow between the gensets and the utility power line 26. FIG. 3D depicts the screen 52 in the Unload Utility operating state in which part of the power requirement of the load 40 can be satisfied by both the gensets G1 and G2 and the utility company 20. The monitor section 204 of this display has a pair of bar graphs that indicate the amount of power being contributed by the gensets and the utility company.

Because the state machine chart 201 is displayed in section 200 and the presently active operating state is indicated thereon, the operator can clearly see and intuitively understand the consequences of any action he/she might take. Referring to FIG. 3B, for example, if one of the two genset s G1 or G2 should properly come on-line, but not the other, the operator can depress a “Bypass” button 226 to cause the system to transition to the next operating state indicated by function block 210. This consequence is graphically indicated on the display.

It should be apparent that the information displayed on the operator interface panel 50 is considerably simplified by dividing the task into operating states. Rather than displaying status and values of all the possible system operating parameters at once, only those operating parameters pertinent to the presently active operating state are displayed. The operator is thus prompted only with the parameters that need to be monitored while in the presently active operating state. The operator is also prompted with the actions that can be taken while in the presently active operating state and the consequences of any action is indicated graphically. Actions that only can be taken in other non-active operating states are not presented to the operator and thus that person is not distracted by useless information.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

I claim:

1. An operator interface panel for electrical switchgear comprising:
a screen having a first section for displaying a state machine chart that indicates a succession of operating states in which the switchgear can function, and a second section for displaying a plurality of icons each depicting an action of the electrical switchgear; and
a manually operated device by which a user selects one of the plurality of icons thereby directing the electrical switchgear to perform the action depicted by the one of the plurality of icons that is selected.

2. The operator interface panel as recited in claim 1 in which the manually operated device comprises a mechanism for sensing the user touching the screen.

3. The operator interface panel as recited in claim 1 in which each of the plurality of icons is shown as being associated with one of the operating states on the state machine chart.

4. The operator interface panel as recited in claim 1 wherein the manually operated device recognizes user selection of only those of the plurality of icons that are associated with one of the operating states in which the switchgear is functioning when the user selection occurs.

5. The operator interface panel as recited in claim 1 wherein the state machine chart indicates in which one of the succession of operating states the switchgear is functioning.

6. The operator interface panel as recited in claim 1 wherein the screen comprises a third section for displaying an indication of operational parameters of the switchgear.

7. An operator interface panel for electrical switchgear that controls application of electricity from a first source and a second source to a load, the operator interface panel comprising:
a screen having a first section for displaying a state machine chart that indicates a succession of operating states in which the switchgear can function, a second section for displaying a plurality of icons each designating an action of the electrical switchgear, and a third section for displaying operational parameters of the switchgear; and
a manually operated device by which a user selects one of the plurality of icons thereby directing the electrical switchgear to perform the action designated by the one of the plurality of icons that is selected.

8. The operator interface panel as recited in claim 7 wherein the operational parameters are selected from voltage, amperage, wattage, frequency, phase angle, and power factor.

9. The operator interface panel as recited in claim 7 wherein the third section displays separate operational parameters the first source and the second source.

10. The operator interface panel as recited in claim 7 in which the manually operated device comprises a mechanism for sensing the user touching the screen.

11. The operator interface panel as recited in claim 7 in which each of the plurality of icons is shown as being associated with one of the operating states on the state machine chart.

12. The operator interface panel as recited in claim 7 wherein the manually operated device recognizes user selection of only those of the plurality of icons that are associated with one of the operating states in which the switchgear is functioning when the user selection occurs.

13. The operator interface panel as recited in claim 7 in which the state machine chart indicates in which one of the succession of operating states the switchgear is functioning.

14. An operator interface panel for electrical switchgear that functions in a plurality of operating states, each of which becomes a presently active state at different times, the operator interface panel comprising;
a first display which produces a state machine chart indicating the plurality of operating states;
a touch-panel display adjacent the first display and indicating one or more actions that the electrical switchgear is capable of performing; and
a second display for indicating values for operational parameters of the electrical switchgear in the presently active state.

15. The operator interface panel as recited in claim 14 in which the first display, the second display and the touch-panel display are different sections of a single touch screen display device.

16. The operator interface panel as recited in claim 14 in which the presently active state is indicated on the state machine chart.

17. The operator interface panel as recited in claim 14 in which each operator input command is displayed as being associated with one of the operating states on the state machine chart.

18. The operator interface panel as recited in claim 14 wherein the touch-panel display presents an icon that is associated with each action, wherein when a user touches the touch-panel display near a given icon, a signal is produced that corresponds to the action associated with the given icon.

19. The operator interface panel as recited in claim 18 wherein the touch-panel display produces the signal only if the given icon is related to the presently active state.

20. The operator interface panel as recited in claim 14 wherein the operational parameters are selected from voltage, amperage, wattage, frequency, phase angle, and power factor.
